(19) United States
(12) Patent Application Publication
(10) Pub. No.: US 2022/0148574 A1
(43) Pub. Date: May 12, 2022

(54) HYBRID VOICE INTERACTION SYSTEM AND HYBRID VOICE INTERACTION METHOD

(71) Applicant: FAURECIA CLARION ELECTRONICS CO., LTD., Saitama-shi, Saitama (JP)

(72) Inventors: Hiroaki KOKUBO, Chiyoda-ku (JP); Takeshi HOMMA, Chiyoda-ku, (JP); Masataka MOTOHASHI, Saitama-shi (JP)

(21) Appl. No.: 17/310,822

(22) PCT Filed: Feb. 21, 2020
(86) PCT No.: PCT/JP2020/007154

§ 371 Date: Aug. 25, 2021

(30) Foreign Application Priority Data
Feb. 25, 2019 (JP) 2019-031895

(51) Int. Cl. G10L 15/08; G10L 13/02

(52) U.S. Cl. CPC G10L 15/08; G10L 2015/088; G10L 13/02

(57) ABSTRACT

Interaction response promptness is ensured in a hybrid voice interaction system. A voice interaction terminal includes a keyword recognition unit which recognizes a predetermined keyword from a voice uttered by a user and a response sentence generation unit which generates a first response sentence on the basis of the keyword. A voice interaction server includes a voice recognition unit which recognizes voice data sent from the voice interaction terminal and an interaction management unit which generates a second response sentence on the basis of a voice recognition result and manages the keyword to be recognized by the keyword recognition unit on the basis of a predetermined interaction scenario. The hybrid voice interaction system further includes an output unit which outputs the first response sentence generated by the response sentence generation unit or the second response sentence sent from the voice interaction server.

### TECHNICAL FIELD

The present invention generally relates to a hybrid voice interaction system and a hybrid voice interaction method.

### BACKGROUND ART

Since cloud voice recognition needs exchange of voice through public lines, recognition processing takes a long time period. For this reason, a strategy for avoiding a delay of a response which is expected to largely affect usability is strongly demanded in voice interaction based on cloud voice recognition. One of methods for avoiding the problem is hybrid voice recognition that is implemented using both cloud voice recognition and terminal voice recognition.

PTL 1 describes means for determining which one of terminal voice recognition and cloud voice recognition to use so as to maximize user satisfaction level under constraint conditions which achieve both a satisfactory response time period and a satisfactory recognition rate, with regard to hybrid voice recognition.

### CITATION LIST

### Patent Literature

[PTL 1] Japanese Patent Laid-Open No. 2018-081185

### SUMMARY OF INVENTION

### Technical Problem

PTL 1 assumes a task recognizable to both terminal voice recognition and cloud voice recognition.

However, since a terminal is limited in computational resources, such as a memory and a CPU, there are constraints on vocabulary and expressions recognizable to terminal voice recognition. Thus, when hybrid voice recognition is applied to a voice interaction system, the system needs to be constructed on the premise that all user utterances cannot always be recognized on a terminal side. When attempts to construct the system are made on the premise, it is difficult for the hybrid voice recognition according to PTL 1 to ensure interaction response promptness.

It is an object of the present invention to ensure interaction response promptness in a hybrid voice interaction system.

### Solution to Problem

A hybrid voice interaction system according to one aspect of the present invention is a hybrid voice interaction system including a voice interaction terminal which has an interaction based on a voice with a user and a voice interaction server which exchanges voice data with the voice interaction terminal, wherein the voice interaction terminal includes a keyword recognition unit which recognizes a predetermined keyword from the voice uttered by the user and a response sentence generation unit which generates a first response sentence on the basis of the keyword recognized by the keyword recognition unit, and the voice interaction server includes a voice recognition unit which recognizes the voice data sent from the voice interaction terminal and an interaction management unit which generates a second response sentence on the basis of a voice recognition result obtained through the recognition by the voice recognition unit and manages the keyword to be recognized by the keyword recognition unit on the basis of a predetermined interaction scenario, and the hybrid voice interaction system further includes an output unit which outputs the first response sentence generated by the response sentence generation unit or the second response sentence sent from the voice interaction server.

A hybrid voice interaction method according to one aspect of the present invention is a hybrid voice interaction method in a hybrid voice interaction system including a voice interaction terminal which has an interaction based on a voice with a user and a voice interaction server which exchanges voice data with the voice interaction terminal, the method including: recognizing, by the voice interaction terminal, a predetermined keyword from the voice uttered by the user and generating a first response sentence on the basis of the recognized keyword; recognizing, by the voice interaction server, the voice data sent from the voice interaction terminal, generating a second response sentence on the basis of a voice recognition result obtained through the recognition, and managing the keyword to be recognized on the basis of a predetermined interaction scenario; and outputting the first response sentence generated by the voice interaction terminal or the second response sentence generated by the voice interaction server.

### Advantageous Effects of Invention

According to the aspect of the present invention, it is possible to ensure interaction response promptness in the hybrid voice interaction system.

### BRIEF DESCRIPTION OF DRAWINGS

FIG. 1 is a diagram showing one example of a functional configuration of a hybrid voice interaction system according to an embodiment;

FIG. 2 is a chart showing one example of a correspondence list with keywords and response sentences according to the embodiment;

FIG. 3 is a chart showing one example of an interaction scenario according to the embodiment;

FIG. 4 is a chart showing one example of a table of correspondence between awaiting state numbers and keyword lists for response processing to be requested from a voice interaction terminal in the interaction scenario according to the embodiment;

FIG. 5 is a chart showing one example of a table of correspondence among awaiting state numbers, keyword lists for response processing to be requested from the voice interaction terminal, and response sentences in the interaction scenario according to the embodiment;

FIG. 6 is a flowchart showing one example of processing by the hybrid voice interaction system according to the embodiment; and

FIG. 7 is a chart showing one example of a voice interaction sequence according to the embodiment.

### DESCRIPTION OF EMBODIMENTS

An embodiment of the present invention will be described below with reference to the drawings.

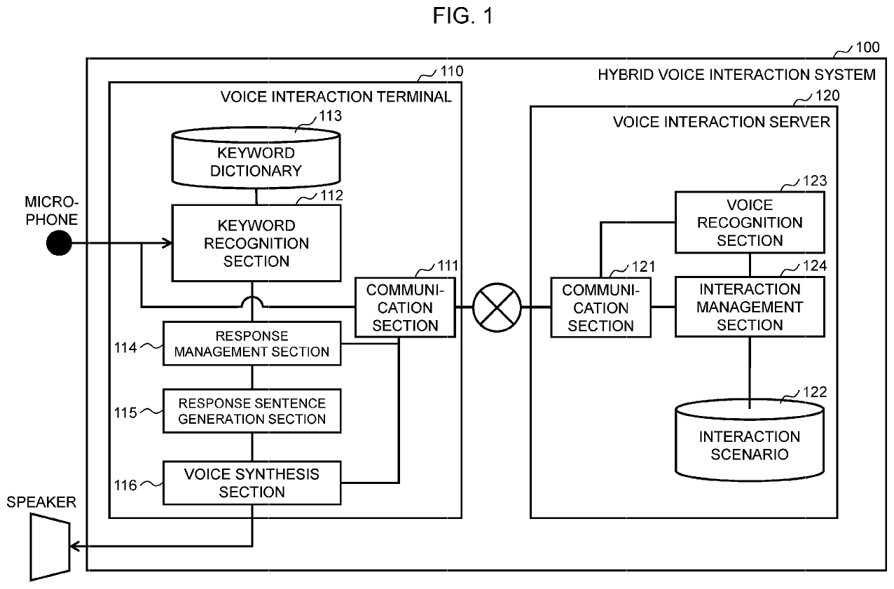

A functional configuration of a hybrid voice interaction system 100 according to the embodiment will be described with reference to FIG. 1.

The hybrid voice interaction system 100 is composed of a voice interaction terminal 110 and a voice interaction server 120. The voice interaction terminal 110 is an apparatus for providing information that a user wants or performing equipment operation or the like that the user desires by having a voice-based interaction with the user. The voice interaction terminal 110 is composed of a communication unit 111, a keyword recognition unit 112, a keyword dictionary 113, a response management unit 114, a response sentence generation unit 115, and a voice synthesis unit 116. The communication unit 111 communicates with the voice interaction server 120 through a communication line and is responsible for exchanging data, such as voice.

The keyword recognition unit 112 recognizes (extracts) only a particular keyword from a voice uttered by a user. The keyword need not be a word or a group of words, such as “Japanese food” or “Western food,” and may be a phrase, such as “No, I don't” or “Yes, I do.” The number of keywords to be recognized is not limited to one, and there may be a plurality of keywords to be recognized. The keyword dictionary 113 is a dictionary in which keywords to be recognized by the keyword recognition unit 112 are registered. Thus, keywords to be recognized by the keyword recognition unit 112 are only those registered in the keyword dictionary 113. Note that a detailed description of a keyword recognition algorithm is given in, for example, Seiichi Nakagawa, “Speech Recognition Based on Stochastic Models,” The Institute of Electronics, Information and Communication Engineers.

The response management unit 114 communicates with the voice interaction server 120 via the communication unit 111, checks whether to make a voice response in the voice interaction terminal 110, and receives a keyword list to be awaited by the keyword recognition unit 112 from the voice interaction server 120. When the voice interaction terminal 110 is to make a voice response, the response management unit 114 sends the keyword list received from the voice interaction server 120 to the keyword recognition unit 112 and requests keyword recognition. When keyword recognition is performed by the keyword recognition unit 112, the response management unit 114 receives a recognized keyword, sends the received keyword to the response sentence generation unit 115, and requests response sentence generation.

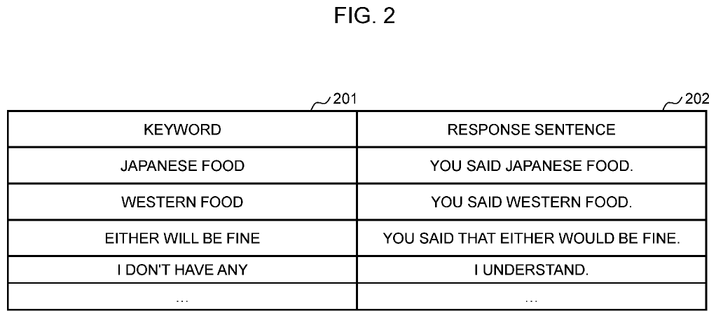

The response sentence generation unit 115 generates a response sentence (text) on the basis of a keyword received from the response management unit 114. As for the response sentence generation, the response sentence generation unit 115 may hold a received keyword 201 and a corresponding response sentence 202 as a pair in list form, as in FIG. 2, and generate a response sentence by referring to the list. Alternatively, the response sentence generation unit 115 may prepare in advance a rule, such as generating a response sentence by adding “You said” to a keyword, and generate a response sentence. The voice synthesis unit 116 synthesizes a voice on the basis of a response sentence generated by the response sentence generation unit 115 or a response sentence input from the voice interaction server 120 via the communication unit 111 and outputs the voice to a speaker.

The voice interaction server 120 will be described.

The voice interaction server 120 is composed of a communication unit 121, an interaction scenario 122, a voice recognition unit 123, and an interaction management unit 124. The communication unit 121 communicates with the voice interaction terminal 110 through the communication line and is responsible for exchanging data, such as voice. In the interaction scenario 122, a user utterance intention estimated from a user utterance and a corresponding response from the system as a pair are described as a transition state corresponding to the flow of an interaction.

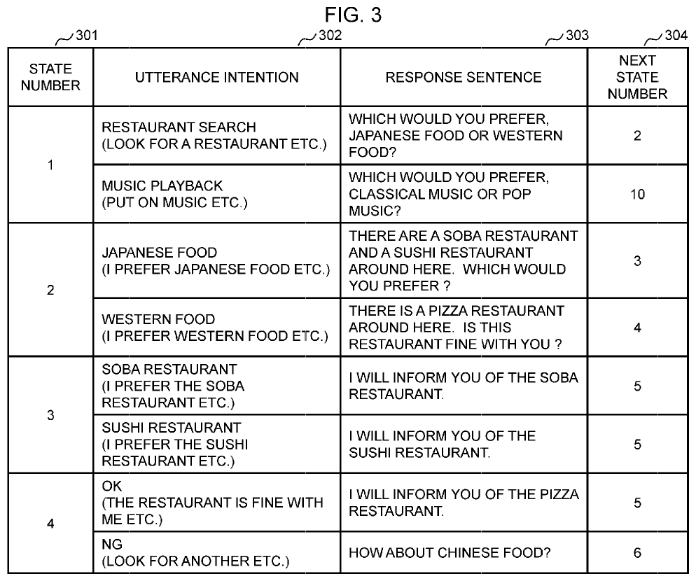

The interaction scenario 122 will be described with reference to FIG. 3. FIG. 3 illustrates an example of an interaction scenario simplified for ease of explanation.

In the example, a status number 301 indicates a transition state corresponding to the flow of an interaction. An utterance intention 302 is a concept abstracted from various expressions in user utterances. For example, “restaurant search” is defined as a concept representing various expressions, such as “I want you to look for a restaurant,” “Look for a restaurant,” and “I want to eat something.” Note that the piece of writing in parentheses of “(Look for a restaurant etc.)” in the utterance intention 302 just illustrates an utterance example for clarity of explanation and need not be actually defined. As a response sentence 303, a response sentence (text) to be sent in reply by the system if the utterance intention 302 is estimated on the condition that the hybrid voice interaction system 100 is awaiting with the state number 301 is defined. A next state number 304 designates the state number 301 when the hybrid voice interaction system 100 awaits an utterance to be issued in reply by a user after the system returns a response sentence defined by the response sentence 303.

The voice recognition unit 123 recognizes a voice input from the voice interaction terminal 110 via the communication unit 121. As in FIG. 1, the voice recognition unit 123 may be in the voice interaction server 120, or an external voice recognition server may be used.

The interaction management unit 124 refers to the interaction scenario 122, generates a response sentence from a voice recognition result obtained from the voice recognition unit 123, holds a transition state as the state number 301, and manages voice interaction behavior. More specifically, the interaction management unit 124 receives the voice recognition result from the voice recognition unit 123 and estimates an utterance intention. For example, the interaction management unit 124 compares the estimated utterance intention with the utterance intentions 302 of the interaction scenario 122 and generates the appropriate response sentence 303.

For example, assume that an utterance intention of a voice recognition result obtained from the voice recognition unit 123 is “restaurant search” when the state number 301 is 1. In this case, the interaction management unit 124 generates the response sentence “Which would you prefer, Japanese food or Western food?” by referring to the interaction scenario 122. The hybrid voice interaction system 100 transitions to a state number of 2 as the next state number 304. The interaction management unit 124 awaits an utterance intention of “Japanese food” or “Western food” as a next reply utterance of a user.

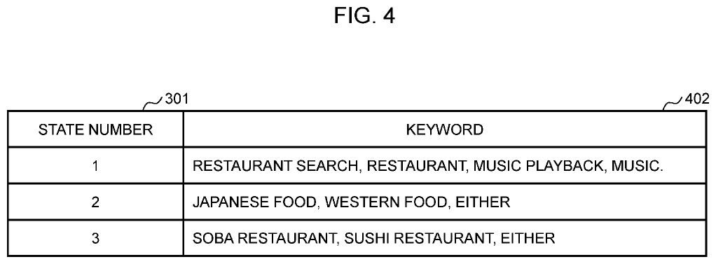

The interaction management unit 124 requests, from the voice interaction terminal 110, response processing based on keyword recognition through the communication unit 121. FIG. 4 illustrates an example of a table of correspondence between the state numbers 301 of the interaction scenario 122 and keyword lists 402 for response processing to be requested from the voice interaction terminal 110. A keyword list 402 may be one or more keywords. Note that since keywords recognizable to the voice interaction terminal 110 are limited to those registered in the keyword dictionary 113, a keyword to be registered in the keyword list 402 at the time of scenario designing is selected from vocabulary in the keyword dictionary 113.

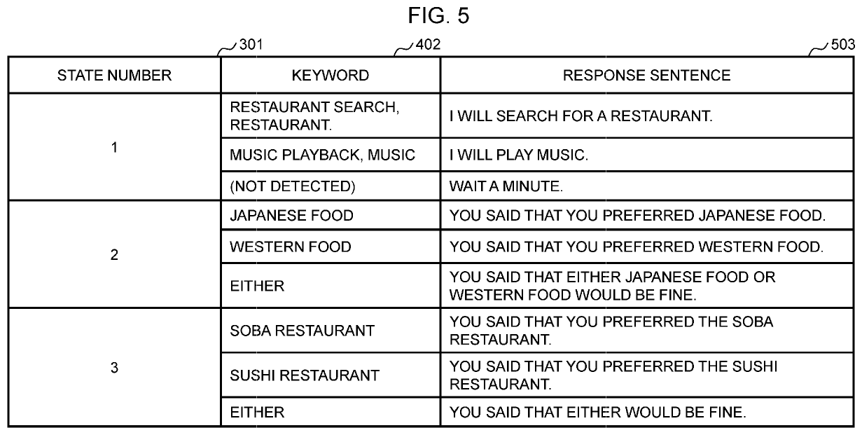

When the state number 301 is such that what reply a user will give is unpredictable, it is also possible to empty a keyword list and choose not to request response processing from the voice interaction terminal 110. Additionally, response sentences 503 for the voice interaction terminal 110 may be defined in advance by the interaction management unit 124, as in FIG. 5, instead of generating a response sentence by the response sentence generation unit 115, as in FIG. 2. A keyword list for requested response processing and a response sentence may be simultaneously announced to the voice interaction terminal 110. A response sentence to be generated when the keyword recognition unit 112 fails to recognize a keyword may be defined.

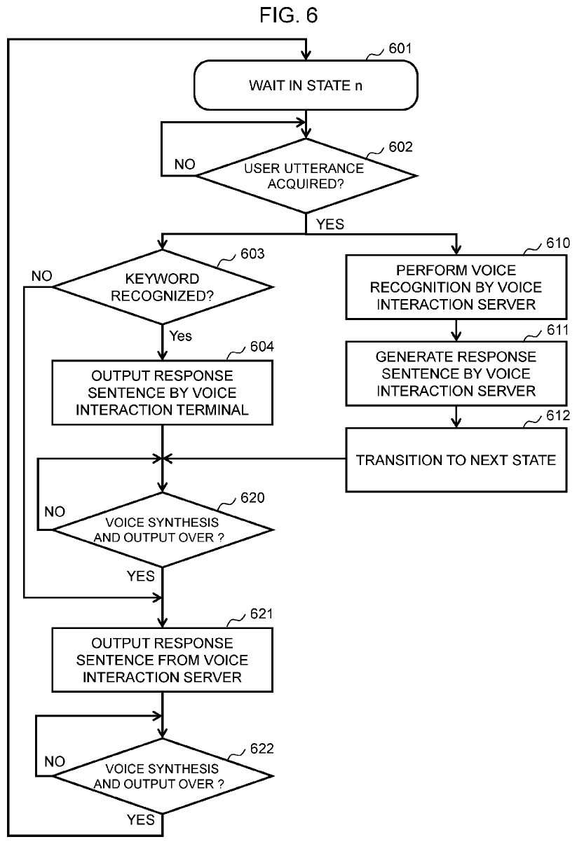

The flow of processing by the hybrid voice interaction system 100 will be described with reference to the processing flow in FIG. 6.

As an example, assume that the hybrid voice interaction system 100 is awaiting an utterance from a user with the state number 301 of 1 in the scenario of FIG. 3 (step 601). At this time, in the voice interaction terminal 110, the keyword list 402 for the state number 301 of 1 in FIG. 4 is sent from the voice interaction server 120 to the response management unit 114, and the keyword recognition unit 112 awaits recognition of a keyword in question. When a user utterance is input (step 602), the keyword recognition unit 112 recognizes a keyword to be awaited (step 603).

When a keyword is recognized by the keyword recognition unit 112 (YES in step 603), the response management unit 114 receives the recognized keyword and requests, from the response sentence generation unit 115, response sentence generation (text). A response sentence generated by the response sentence generation unit 115 is converted into a synthetic voice by the voice synthesis unit 116 and output to the speaker, and the synthetic voice is played toward the user through the speaker (step 604). When the user does not utter a keyword to be awaited, that is, no keyword is recognized by the keyword recognition unit 112 (NO in step 603), the response management unit 114 skips an interaction response (step 604) in the voice interaction terminal 110.

When the user utterance is also input to the voice interaction server 120 (step 602), voice data is sent to the voice recognition unit 123 through the communication unit 121, and voice recognition is performed (step 610). When a voice recognition result is obtained, the interaction management unit 124 generates a response sentence, and the response sentence is transmitted to the voice interaction terminal 110 through the communication unit 121 (step 611). A state transition is made to a next state (the next state number 304) defined in the scenario (step 612). For example, when the voice recognition result is “restaurant search,” the next state (the next state number 304) is 2. When the voice recognition result is “music playback,” the next state (the next state number 304) is 10.

The voice synthesis unit 116 receives the response sentence (text) transmitted from the voice interaction server 120 and converts the received response sentence into a synthetic voice. At this time, the voice synthesis unit 116 checks whether the voice synthesis of the response sentence by the voice interaction terminal 110 in step 604 is complete (step 620). When the voice synthesis is not complete, the voice synthesis unit 116 waits for the voice synthesis to be completed (NO in step 620). When the voice synthesis and playback is complete (YES in step 620), the synthetic voice for the response sentence received from the voice interaction server 120 is played through the speaker (step 621). When the playback of the synthetic voice is completed (step 622), the hybrid voice interaction system 100 returns to step 601 and awaits a voice from the user in the state selected in step 612.

Generally, a public network is used for communication between the voice interaction terminal 110 and the voice interaction server 120. For this reason, there is a time lag between transmission of voice data from the voice interaction terminal 110 to the voice interaction server 120 and return of a response sentence generated in the voice interaction server 120 to the voice interaction terminal 110.

In the case of a question-and-answer interaction, some increase in a time period for a response is allowable to some extent. In the case of a voice interaction premised on a plurality of answers, a delay of a response is expected to largely affect usability. The interaction response (step 604) in the voice interaction terminal 110 contributes to filling a waiting time period for a system response caused by the time lag and ensuring response promptness to be felt by a user.

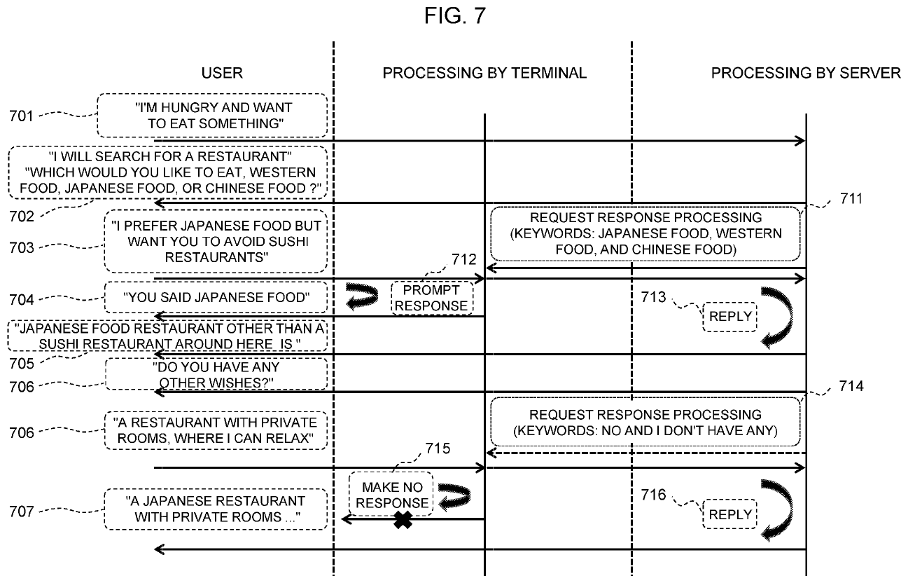

Operation of the hybrid voice interaction system according to the embodiment will be described using a concrete interaction example. FIG. 7 is a chart for explaining an interaction sequence of the hybrid voice interaction system of the embodiment.

First, assume that a user utters a voice saying, “I'm hungry and want to eat something” (step 701). Also, assume that the question “I will search for a restaurant. Which would you like to eat, Western food, Japanese food, or Chinese food?” (step 702) is returned from the system. At this time, the user is required to select from among the candidates, “Western food,” “Japanese food,” and “Chinese food.” The user is highly likely to select one among the candidates in reply. Thus, the voice interaction server 120 requests, from the voice interaction terminal 110, recognition of the three keywords, “Western food,” “Japanese food,” and “Chinese food” (step 711).

As a concrete flow of processing, as described earlier, the keyword list 402 described in the scenario is sent from the voice interaction server 120 to the response management unit 114, and the keyword recognition unit 112 awaits recognition of a keyword in question.

Assume that the user replies, “I prefer Japanese food but want you to avoid sushi restaurants” (step 703). The reply utterance is almost simultaneously transmitted to the voice interaction terminal 110 and the voice interaction server 120, and response sentences are generated after voice recognition processing.

As described earlier, since a public network is often used for data transmission to the voice interaction server 120, there is a time lag between when the user utterance is sent from the voice interaction terminal 110 and when a generated response sentence returns to the voice interaction terminal 110.

Response generation in the voice interaction terminal 110 does not suffer from communication bottlenecks, and vocabulary to be recognized is limited to particular keywords. Thus, a response sentence can be generated almost without a delay. Note that since a recognizable keyword in the user utterance “I prefer Japanese food but want you to avoid sushi restaurants” (step 703) is only “Japanese food,” an intention of the user corresponding to “I want you to avoid sushi restaurants” is ignored.

However, limited keywords have the advantage that the action of falsely recognizing the part “I want you to avoid sushi restaurants” and returning an inappropriate response is unlikely to occur as a side effect. In the example, the voice interaction terminal 110 just responds promptly (step 712), “You said Japanese food” (step 704).

While a voice is synthesized from the response sentence in the voice interaction terminal 110 and is played through the speaker, the response sentence generated by the voice interaction server 120 arrives at the voice interaction terminal 110 (step 713). After waiting for voice synthesis and playback of “You said Japanese food” (step 704) to be completed, the voice interaction terminal 110 goes on to return the response “Japanese food restaurant other than a sushi restaurant around here is . . . ” (step 705).

As described above, a response sentence generated by the voice interaction terminal 110 is inserted in a time period to when a response sentence generated by the voice interaction server 120 is returned. This makes it possible to fill a waiting time period felt by a user and ensures interaction response promptness.

Possible replies from the user to the question “Do you have any other wishes?” (step 706) from the system are diverse, and it is difficult to design keywords to be awaited. However, when the user has no other wishes, a reply is predictable to some extent. For example, the voice interaction terminal 110 may be requested to respond using “No” or “I don't have any” as a keyword to be awaited (step 714).

Assume that a reply from the user at the time is an utterance with no keyword (step 706). In this case, since the keyword recognition unit 112 is unable to recognize a keyword, the voice interaction terminal 110 does not make a prompt response (step 715), and only a response from the voice interaction server 120 is made (step 716). Of course, it is also possible to define a sentence for responding when keyword recognition is unsuccessful (e.g., “Wait a minute” or “I will look for one meeting conditions you wish”) and fill a waiting time period for the user. As for processing when keyword recognition is unsuccessful, for example, whether to make a prompt response may be judged in accordance with, e.g., a communication status of the hybrid voice interaction system 100, and processing may be performed on the basis of a result of the judgment.

In the hybrid voice interaction system according to the above-described embodiment, when limited keywords are expected to be included in contents of a reply from a user, response processing for filling a time period while waiting during processing on the server side is performed on the terminal side. As a result, interaction response promptness is ensured, and a voice interaction with high naturalness can be implemented.

As for playback toward a user in the hybrid voice interaction system according to the embodiment, an example has been illustrated in which a response sentence generated by the response sentence generation unit 115 or a response sentence input from the voice interaction server 120 via the communication unit 111 is converted into a synthetic voice by the voice synthesis unit 116 and the synthetic voice obtained through the conversion by the voice synthesis unit 116 is played toward the user through the speaker.

The present invention, however, is not limited to the embodiment. When a display (not shown) is coupled to the hybrid voice interaction system 100 in addition to the speaker in FIG. 1, the voice synthesis unit 116 may function as an output unit which outputs, to the display, text information based on a response sentence generated by the response sentence generation unit 115 or a response sentence input from the voice interaction server 120 via the communication unit 111. A combination of a speaker and a display is not limited to this example, and either one may be used.

The above description can be summed up, for example, in the following manner.

### Expression 1

The hybrid voice interaction system 100 includes the voice interaction terminal 110 (or a voice interaction unit which is implemented in a user terminal (e.g., an information processing terminal like a smartphone) capable of communication with the voice interaction server 120) that has an interaction based on a voice with a user, and the voice interaction server 120 that exchanges voice data with the voice interaction terminal 110 (or the voice interaction unit). The voice interaction terminal 110 includes the keyword recognition unit 112 that recognizes a predetermined keyword from the voice uttered by the user and the response sentence generation unit 115 that generates a first response sentence on the basis of the keyword recognized by the keyword recognition unit 112. The voice interaction server 120 includes the voice recognition unit 123 that recognizes the voice data sent from the voice interaction terminal 110 and the interaction management unit 124 that generates a second response sentence on the basis of a voice recognition result obtained through the recognition by the voice recognition unit 123 and manages the keyword to be recognized by the keyword recognition unit 112 on the basis of the predetermined interaction scenario 122. The hybrid voice interaction system 100 includes an output unit which outputs the first response sentence generated by the response sentence generation unit 115 or the second response sentence sent from the voice interaction server 120. The above-mentioned voice interaction unit may be a function for having an interaction based on a voice with a user, and may be realized by allowing the user terminal to execute a program such as an application program. The voice interaction unit may include the keyword recognition unit 112 and the response sentence generation unit 115. The voice interaction unit may further include the response management unit 114.

In a voice interaction, a user has a waiting time period (e.g., since a public network is often used for data transmission to the voice interaction server 120, there is a time lag between when a user utterance is sent from the voice interaction terminal 110 and when the generated second response sentence returns to the voice interaction terminal 110), which is one of technical problems. The hybrid voice interaction system 100 according to Expression 1 can insert the first response sentence generated by the voice interaction terminal 110 in a time period to when the second response sentence generated by the voice interaction server 120 is returned. This makes it possible to fill a waiting time period felt by the user (in other words, give the user the sensation that the waiting time period is short). As a result, interaction response promptness is ensured.
For example, in the hybrid voice interaction system 100 according to Expression 1, the voice interaction terminal 110 may include the communication unit 111 that transmits data, such as voice data representing a voice uttered by the user, to the voice interaction server 120 or receives data, such as the second response sentence, from the voice interaction server 120. The voice interaction server 120 may include the communication unit 121 that receives data, such as voice data, from the voice interaction terminal 110 or transmits data, such as the second response sentence, to the voice interaction terminal 110. In the voice interaction terminal 110, the communication unit 111 may transmit voice data of the voice to the voice interaction server 120 in parallel with the recognition of the predetermined keyword from the voice uttered by the user by the keyword recognition unit 112. The output unit (e.g., the voice synthesis unit 116) may output the first response sentence when the first response sentence is generated by the response sentence generation unit 115. When the communication unit 111 receives the second response sentence from the voice interaction server 120 after that, the output unit may output the second response sentence. A waiting time period felt by the user may be filled in the above-described manner. The output unit can output at least one of the first response sentence and the second response sentence.

### Expression 2

In the hybrid voice interaction system 100 according to Expression 1, the response sentence generation unit 115 may generate the first response sentence that pairs up with the keyword. Since the first response sentence can be acquired from table-like information using the recognized keyword as a key, a processing load on the voice interaction terminal 110 (e.g., an in-vehicle machine) can be made lighter than an algorithm that constructs a sentence on the basis of a keyword. This enhances the response promptness of the voice interaction terminal 110. Additionally, information to be received from the voice interaction server 120 may be a keyword that is a part of a sentence, and data traffic between the voice interaction terminal 110 and the voice interaction server 120 can be reduced.

### Expression 3

In the hybrid voice interaction system 100 according to Expression 1 or 2, the response sentence generation unit 115 may generate the first response sentence from the keyword in accordance with a predetermined rule. Since the first response sentence can be acquired using the recognized keyword on the basis of the rule, the processing load on the voice interaction terminal 110 (e.g., an in-vehicle machine) can be made lighter than an algorithm that constructs a sentence on the basis of a keyword. This enhances the response promptness of the voice interaction terminal 110. Additionally, information to be received from the voice interaction server 120 may be a keyword that is a part of a sentence, and the data traffic between the voice interaction terminal 110 and the voice interaction server 120 can be reduced.

### Expression 4

In the hybrid voice interaction system 100 according to any one of Expressions 1 to 3, the response sentence generation unit 115 may generate a third response sentence independent of the keyword when the keyword recognition unit 112 fails to recognize the keyword. The output unit may output the third response sentence generated by the response sentence generation unit 115. One of technical problems is that a keyword is not always recognized in a voice interaction. When no keyword is recognized, the hybrid voice interaction system 100 according to Expression 4 inserts the third response sentence generated by the voice interaction terminal 110 in a time period to when the second response sentence generated by the voice interaction server 120 is returned. This makes it possible to fill a waiting time period felt by the user (in other words, give the user the sensation that the waiting time period is short). As a result, the interaction response promptness is ensured.

### Expression 5

In the hybrid voice interaction system 100 according to Expression 4, the interaction management unit 124 may manage the first response sentence and the third response sentence to be generated by the response sentence generation unit 115. In this manner, centralized control of pieces of latest data of the individual voice interaction terminals 110 can be performed on the voice interaction server 120 side without updating on the individual voice interaction terminals 110 side. For example, the interaction management unit 124 may transmit the pieces of latest data of the individual voice interaction terminals 110 to all or some of the voice interaction terminals 110.

### Expression 6

In the hybrid voice interaction system 100 according to any one of Expressions 1 to 5, the voice interaction terminal 110 may further include the response management unit 114 that receives, from the voice interaction server 120, a keyword list related to the keyword to be recognized by the keyword recognition unit 112. The response management unit 114 may send the keyword list received from the voice interaction server 120 to the keyword recognition unit 112 and request recognition of the keyword when the voice interaction terminal 110 is to make a voice response. The response management unit 114 may send the keyword to the response sentence generation unit 115 when the keyword is recognized by the keyword recognition unit 112. The response sentence generation unit 115 may generate the first response sentence on the basis of the keyword received from the response management unit 114. Since the voice interaction terminal 110 includes the response management unit 114 as described above, the voice interaction terminal 110 need not transmit, to the voice interaction server 120, every inquiry as to when to perform voice recognition and when to produce an output when the voice interaction terminal 110 is to make a voice response to the user. This enhances the response promptness. Additionally, the voice interaction server 120 need not receive every inquiry as to when to perform voice recognition and when to produce an output from the voice interaction terminal 110 and can concentrate resources of the voice interaction server on processes, such as voice data recognition and generation of the second response sentence. Thus, enhancement of efficiency of the hybrid voice interaction system 100 can be expected.

### Expression 7

In the hybrid voice interaction system 100 according to any one of Expressions 1 to 6, the output unit may be composed of the voice synthesis unit 116 provided in the voice interaction terminal 110. The voice synthesis unit 116 may synthesize a voice on the basis of the first response sentence generated by the response sentence generation unit 115 or the second response sentence sent from the voice interaction server 120. Since the voice interaction terminal 110 includes the voice synthesis unit 116, the voice interaction server 120 need not generate voice information and send the voice information to the voice interaction terminal 110. This reduces data traffic and enhances the response promptness.

### Expression 8

A method according to Expression 8 is a hybrid voice interaction method in the hybrid voice interaction system 100 including the voice interaction terminal 110 that has an interaction based on a voice with a user and the voice interaction server 120 that exchanges voice data with the voice interaction terminal 110. The voice interaction terminal 110 recognizes a predetermined keyword from the voice uttered by the user and generates a first response sentence on the basis of the recognized keyword. The voice interaction server 120 recognizes the voice data sent from the voice interaction terminal 110 and generates a second response sentence on the basis of a recognition result for the recognized voice data. The voice interaction server 120 manages the keyword to be recognized on the basis of a predetermined interaction scenario. The hybrid voice interaction method according to Expression 8 outputs the first response sentence generated by the voice interaction terminal 110 or the second response sentence generated by the voice interaction server 120. The hybrid voice interaction method according to Expression 8 can fill a waiting time period felt by the user, like the hybrid voice interaction system 100 according to Expression 1.

### Expression 9

In the hybrid voice interaction method according to Expression 8, the voice interaction terminal 110 may await recognition of the keyword. The voice interaction terminal 110 may recognize the awaited keyword when an utterance of the user is input. The voice interaction terminal 110 may generate the first response sentence on the basis of the recognized keyword, convert the first response sentence into a first synthetic voice, and output the first synthetic voice when the keyword is recognized. The voice interaction terminal 110 may skip an interaction response by the voice interaction terminal 110, convert the second response sentence generated by the voice interaction server 120 into a second synthetic voice, and output the second synthetic voice when the keyword is not recognized. The hybrid voice interaction method according to Expression 9 skips the interaction response when the keyword is not recognized. This makes it possible to reduce returning of an inappropriate response, as compared to a case where some response sentence is output prior to outputting of the second response sentence despite lack of recognition of the keyword.

### Expression 10

In the hybrid voice interaction method according to Expression 9, when the keyword is recognized, the voice interaction terminal 110 may output the first synthetic voice for the first response sentence generated by the terminal 110 during a time period before the second synthetic voice for the second response sentence generated by the voice interaction server is output. In this manner, a waiting time period felt by the user can be filled.

### Expression 11

In the hybrid voice interaction method according to Expression 10, the voice interaction terminal 110 may check whether the outputting of the first synthetic voice for the first response sentence is complete. The voice interaction terminal 110 may wait for the outputting of the first synthetic voice for the first response sentence to be completed when the outputting of the first synthetic voice for the first response sentence is not complete. The voice interaction terminal 110 may output the second synthetic voice for the second response sentence when the outputting of the first synthetic voice for the first response sentence is complete.
The voice interaction terminal 110 can receive the second response sentence from the voice interaction server 120 before the outputting of the first synthetic voice for the first response sentence is completed. Even in this case, it is possible to maintain outputting of the second response sentence after completion of outputting of the first response sentence, i.e., insertion of the first response sentence before outputting of the second response sentence. As described above, since a configuration in which the second response sentence waits until the outputting of the first response sentence is completed, a more natural response can be output.

### REFERENCE SIGNS LIST

100 hybrid voice interaction system

110 voice interaction terminal

120 voice interaction server

111 communication unit

112 keyword recognition unit

113 keyword dictionary

114 response management unit

115 response sentence generation unit

116 voice synthesis unit

121 communication unit

122 interaction scenario

123 voice recognition unit

124 interaction management unit

1. A hybrid voice interaction system comprising:
a voice interaction terminal which has an interaction based on a voice with a user; and
a voice interaction server which exchanges voice data with the voice interaction terminal,
wherein the voice interaction terminal includes
a keyword recognition unit which recognizes a predetermined keyword from the voice uttered by the user and
a response sentence generation unit which generates a first response sentence on the basis of the keyword recognized by the keyword recognition unit, and
the voice interaction server includes
a voice recognition unit which recognizes the voice data sent from the voice interaction terminal and
an interaction management unit which generates a second response sentence on the basis of a voice recognition result obtained through the recognition by the voice recognition unit and manages the keyword to be recognized by the keyword recognition unit on the basis of a predetermined interaction scenario, and
the hybrid voice interaction system further includes an output unit which outputs the first response sentence generated by the response sentence generation unit or the second response sentence sent from the voice interaction server.

2. The hybrid voice interaction system according to claim 1, wherein the response sentence generation unit generates the first response sentence that pairs up with the keyword.

3. The hybrid voice interaction system according to claim 1, wherein the response sentence generation unit generates the first response sentence from the keyword in accordance with a predetermined rule.

4. The hybrid voice interaction system according to claim 1, wherein the response sentence generation unit generates a third response sentence independent of the keyword when the keyword recognition unit fails to recognize the keyword, and
the output unit outputs the third response sentence generated by the response sentence generation unit.

5. The hybrid voice interaction system according to claim 4, wherein the interaction management unit manages the first response sentence and the third response sentence to be generated by the response sentence generation unit.

6. The hybrid voice interaction system according to claim 1, wherein the voice interaction terminal further includes a response management unit which receives, from the voice interaction server, a keyword list related to the keyword to be recognized by the keyword recognition unit,
the response management unit sends the keyword list received from the voice interaction server to the keyword recognition unit and requests recognition of the keyword when the voice interaction terminal is to make a voice response, and
sends the keyword to the response sentence generation unit when the keyword is recognized by the keyword recognition unit, and the response sentence generation unit generates the first response sentence on the basis of the keyword received from the response management unit.

7. The hybrid voice interaction system according to claim 1, wherein the output unit is composed of a voice synthesis unit provided in the voice interaction terminal, and
the voice synthesis unit synthesizes a voice on the basis of the first response sentence generated by the response sentence generation unit or the second response sentence sent from the voice interaction server.

8. hybrid voice interaction method in a hybrid voice interaction system including a voice interaction terminal which has an interaction based on a voice with a user and a voice interaction server which exchanges voice data with the voice interaction terminal, the method comprising:
recognizing, by the voice interaction terminal, a predetermined keyword from the voice uttered by the user and generating a first response sentence on the basis of the recognized keyword;
recognizing, by the voice interaction server, the voice data sent from the voice interaction terminal, generating a second response sentence on the basis of a recognition result for the recognized voice data and managing the keyword to be recognized on the basis of a predetermined interaction scenario; and
outputting the first response sentence generated by the voice interaction terminal or the second response sentence generated by the voice interaction server.

9. The hybrid voice interaction method according to claim 8, wherein the voice interaction terminal
awaits recognition of the keyword,
recognizes the awaited keyword when an utterance of the user is input, generates the first response sentence on the basis of the recognized keyword, converts the first response sentence into a first synthetic voice, and outputs the first synthetic voice when the keyword is recognized, and
skips an interaction response by the voice interaction terminal, converts the second response sentence generated by the voice interaction server into a second synthetic voice, and outputs the second synthetic voice when the keyword is not recognized.

10. The hybrid voice interaction method according to claim 9, wherein when the keyword is recognized, the first synthetic voice for the first response sentence generated by the voice interaction terminal is output during a time period before the second synthetic voice for the second response sentence generated by the voice interaction server is output.

11. The hybrid voice interaction method according to claim 10, further comprising:
checking whether the outputting of the first synthetic voice for the first response sentence by the voice interaction terminal is complete,
waiting for the outputting of the first synthetic voice for the first response sentence for to be completed when the outputting of the first synthetic voice for the first response sentence is not complete, and
outputting the second synthetic voice for the second response sentence generated by the voice interaction server when the outputting of the first synthetic voice for the first response sentence is complete.
